(19) United States
(12) Patent Application Publication
(10) Pub. No.: US 2023/0229942 A1
(43) Pub. Date: Jul. 20, 2023

(54) DATA OUTPUT COMPARISON VIA ARTIFICIAL INTELLIGENCE ETHICS SCORES

(71) Applicant: Dell Products L.P., Round Rock, TX (US)

(72) Inventors: Stephen J. Todd, North Andover, MA (US); Nicole Reineke, Northborough, MA (US)

(21) Appl. No.: 17/648,434

(22) Filed: Jan. 20, 2022

(51) Int. Cl. G06N 5/04

(52) U.S. Cl. CPC G06N 5/04

(57) ABSTRACT

Ethics-based decision making is disclosed. Outputs of artificial intelligence processes are tagged or labeled with ethics scores. When decisions are made using the outputs, the ethics tag inform the decision engine regarding the ethics of the outputs. The decisions can, based on the ethics scores, proceed or be delayed until additional input is received. In one example, the selection of an asset may depend the output ethics score.

### FIELD OF THE INVENTION

Embodiments of the present invention generally relate to executing real-time decisions using artificial intelligence. More particularly, at least some embodiments of the invention relate to systems, hardware, software, computer-readable media, and methods for making decisions informed, in part, on ethical scores attached to artificial intelligence outputs.

### BACKGROUND

Many businesses and other entities are increasingly making decisions in an automated manner. Artificial intelligence (AI) can generate outputs that may be used to make decisions of different types. Unfortunately, the outputs generated by Al may result in decisions that are unethical. For example, the output of AI may factor race into mortgage loan decisions. An AI analysis of resumes may exclude women. Search engines may return results that are biased against minorities. College application analytics may exclude minorities from consideration.

In these examples (and others), there may be an analytic application that produces an output that results in an unethical or undesired decision. This has several damaging results including the fact that society is negatively impacted and the entity may be subject to fines or other damage. Currently, there is no way to assist an automated framework to determine the ethical context of data or of AI's output.

When an entity is analyzing data and looking for business opportunities, the entity may turn to pubic or internal catalogs of analytic algorithms. Even if there is metadata about these algorithms that relate to their ethical development or capabilities, the output of these algorithms do not convey anything about their ethical development or capabilities.

When AI algorithms are performed, an audit trail is often generated. Similarly, when an AI output is used for processing, the business actuation and associated processing may also be logged. When an audit is later performed in response to a potential ethics violation, the audit may reveal that that there were no protections available to prevent the unethical actuation.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of an ethics engine configured to automate decisions;

FIG. 1B discloses aspects of automated decision making that considers ethics;

FIG. 2 discloses aspects of automated ethic-based decision making;

FIG. 3 discloses aspects of an ethics datastore; and

FIG. 4 discloses aspects of a computing device or a computing system.

### DETAILED DESCRIPTION OF SOME EXAMPLE EMBODIMENTS

Embodiments of the present invention generally relate to automated decision making based on scored outputs. More particularly, at least some embodiments of the invention relate to systems, hardware, software, computer-readable media, and methods for making automated decisions based on ethically scored outputs and/or seeking additional input based on the ethically scored outputs.

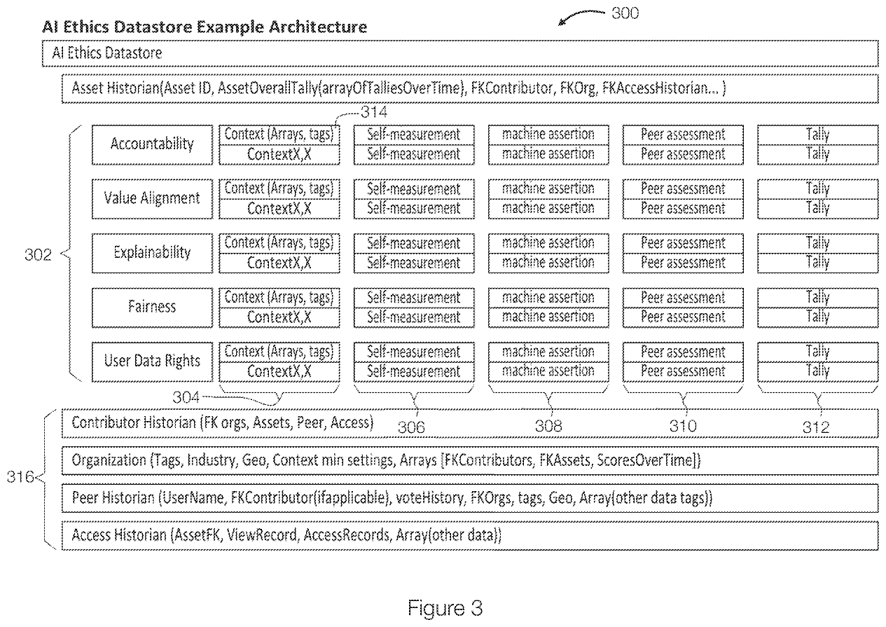

Assets such as algorithms, AI (Artificial Intelligence) platforms comprising hardware and/or software, hardware, software, and the like can be associated with ethical scores. The ethical scores may be determined in accordance with industry recognized pillars such as accountability, value alignment, explainability, fairness, and user data rights. The ethical scores can be stored, monitored, updated, or the like in an ethical datastore, such as illustrated in FIG. 3.

Even though assets may be associated with ethical scores, the outputs of those assets are not associated with ethical scores. A user, for example, may have many asset options when performing a task or developing a workflow. When the workflow includes assets that generate outputs or insights, such as artificial intelligence related assets and those outputs or insights are the basis for automated decisions, embodiments of the invention ensure that the automated decisions can account for the associated ethics. In one example, the outputs of artificial intelligence can be tagged or labeled with an ethical score (e.g., the ethical score of the asset as currently recorded in the ethical datastore). This allows any decisions that are performed using the outputs of the artificial intelligence to account for or consider the ethical implications.

Embodiments of the invention label or tag artificial intelligence outputs with an ethical score using the ethics datastore. When a decision is made based on that output, the decision thus accounts for the ethical score. This provides guiderails that allow an entity to protect itself and others from ethical violations or other ethical problems.

Although embodiments of the invention are discussed in terms of artificial intelligence (AI) and Al outputs, embodiments of the invention may also be used with other automated processes that may generate outputs or insights that are used in automated decisions such as machine learning models, automated machine learning or the like.

AI, by way of example, generally refers to the ability of a system to mimic or imitate human behavior and perform human tasks. AI systems often process input data to generate insights or outputs. An audit trail is often generated that describes how the insights or outputs were generated and from which assets. Once an output is generated, the output may be input into an automation process to make a decision (e.g., a business decision). For example, an AI process may detect an opportunity that results in a decision to launch an online (e.g., twitter) campaign to generate quick sales. In another example, an AI process may detect an opportunity to reduce water usage by shutting down a sprinkling system in anticipation of precipitation.

Generally, the audit trail is stored in an audit log. The audit trail may identify the steps performed to generate the output and the actuation steps performed automated system. While this type of approach can benefit a business (e.g., increase revenue or decrease costs) by responding quickly, this approach also has risks, particularly when the automated decision may involve or perform an ethical violation.

Ethics scores can be generated and applied to any asset. When the ethics scores are generated and applied, a contextual record may be generated that describes whether the generation of the ethics score for the asset was completed in accordance with an organizations' self-described rules of ethics (context). This results in a score that measures an asset against that context. When all assets are scored against this context, an organization can determine whether a first asset has a higher score than a second asset. The higher score implies a higher level of compliance with a set of rules and the corresponding asset is more likely to be aligned with the ethical context. Embodiments of the invention label AI outputs with ethical scores. This allows the outputs of the assets to be selected and/or used in a manner that better complies with the context or that are more likely to be aligned with the ethical context.

By way of example and not limitation, the ethics score of an asset may be generated as follows. If the asset is registered with the datastore, the score is increased by 1. For each pillar:

increase the score by 1 if the context matches the required organizational content;

determine the self measurement score (as a percentage of context) and increase score between 0-10;

determine the machine assessment score (as a percent of required context) and increase the score between 0-10; and determine if peer scores are present and, as a percent of required context, increase score by 0-10.

The ethics scores may be tallied and may be present in the datastore, as described with respect to FIG. 3. Embodiments of the invention use the ethics scores.

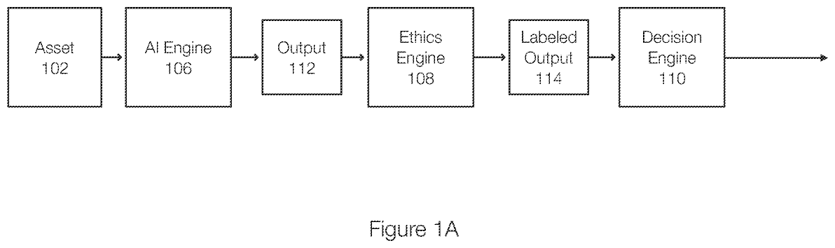

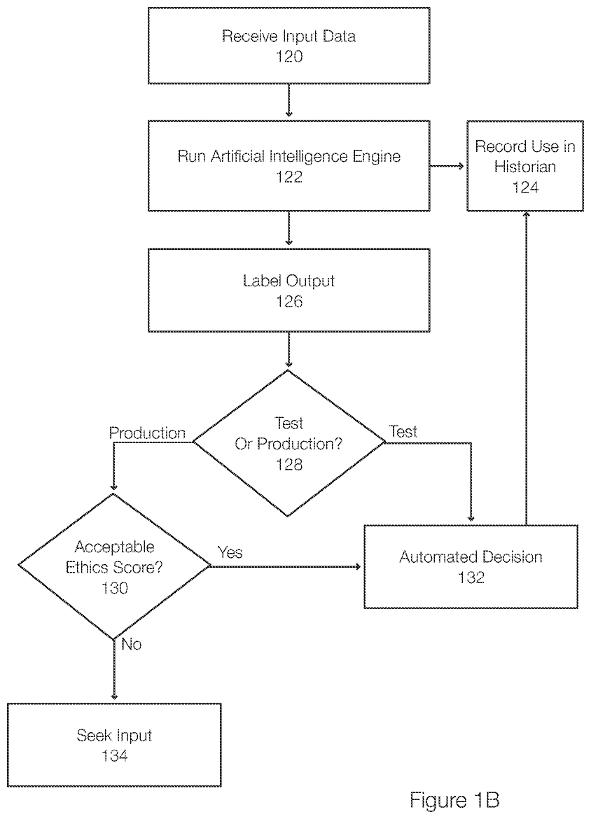

FIG. 1A discloses aspects of an ethics engine configured to participate in automated decisions in a manner such that the automated decision is at least partly ethics-based. In FIG. 1A, an asset 102 may be identified either automatically (e.g., during execution of an application) or by a user. The asset 102 may be an AI algorithm, a data set, hardware, software, or the like or combination thereof.

In this example, the asset 102 may be a data set or other input that is received by an AI engine 106. The AI engine 106 may also be an asset and is an example of artificial intelligence or other machine learning model that is configured to generate an output 112 based on the input or asset 102 in this example.

The output 112 of the AI engine 106 is received or intercepted by an ethics engine 108. The ethics engine 108 may be a physical machine, virtual machine, application, container, or the like. The ethics engine 108 may use the asset identifier (ID) to access the ethics datastore to obtain the ethics score of the asset 102. The output 112 is then tagged or labeled with the ethics score of the asset (and/or the ethics score associated with the AI engine 106) to generate a labeled output 114.

When the labeled output 114 is received or used by the decision engine 110, the decision engine 110 can evaluate the ethics score of the output. If the ethics score is below a threshold, the decision may be deferred or human input may be sought. If the ethics score is above the threshold, the decision engine 110 may perform a decision or action based on the labeled output 114 without further input. This allows automated decisions to be performed in a manner that accounts for ethics and ensures or helps reduce the possibility of automated ethical violations.

FIG. 1B discloses aspects of ethic-based algorithmic selection. In FIG. 1B, input data is received 120 into an AI process. The AI process operates 122 on the input data. These actions are recorded 124 in a historian.

The AI process generates an output or insight that is tagged or labeled 126 by an ethics engine. More specifically, an output metadata tag or label is generated and applied to the output of the AI process. Tagging or labeling the output of the AI process allows data management and utilization processes to be performed based on these labels. For example, AI outputs are typically input into a decision engine to make an automated decision. In one example, a determination 128 is made regarding whether the decision is a test decision or a production decision. If the decision is a test decision, an automated decision is performed 132 and may be recorded 124 in the historian. If the output is being used for a production system, the ethics score of the output of the AI is evaluated 130.

If the score is acceptable (Yes at 130), then the decision is performed 132 and recorded 124 in the historian. If the ethics score is not acceptable (No at 130), input is sought 134. For example, the system or process may seek user input prior to performing or executing the decision. The user requested input may include authorization to proceed, acknowledgment of a potential ethics violation, or the like.

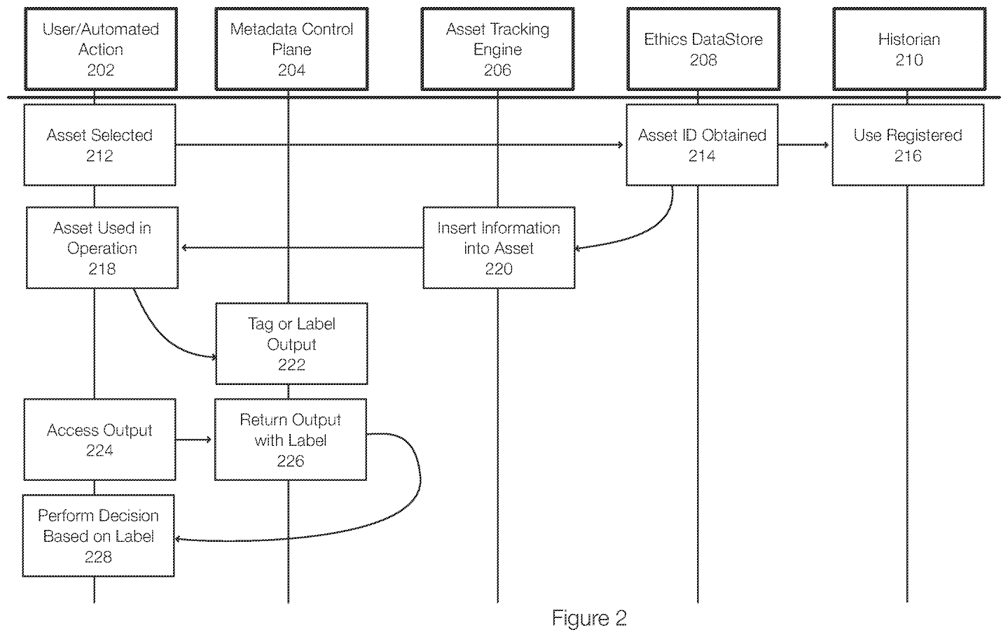

FIG. 2 illustrates a bounce chart further illustrating aspects of automated ethics-based decision making. FIG. 2 illustrates aspects of a decision-making process that may occur at different locations or stages. FIG. 2 illustrates user/automated actions 202, a metadata control plane 204, an asset tracking engine 206 (which is an example of an ethics engine), an ethics datastore 208, and a historian 210.

In FIG. 2, an asset may be selected 212 in an automated manner, such as by an application, or by a user. Once the asset is selected, the asset ID is obtained 214 from the ethics datastore 208. The use (access) of the asset is registered 216 in the historian 210.

The asset tracking engine 206 may include or insert 220 information into the asset (e.g., in a header) or otherwise associate the asset ID (and/or other information) with the asset. The information may include the asset ID, the user assigned, and an asset output unique identifier. Next, the asset is used 218 in an operation (e.g., processed by AI) and an output is generated. The output generated by use of the asset is tagged or labeled 222 with the asset ID and an ethics score. The score may be a number and/or may include details such as details of the asset used to produce the output. In addition to labeling the output with an ethics score associated with the input asset, the output may be labeled with an ethics score of the automated process and/or hardware associated with generating the output.

An automation process (e.g., a decision engine) or user may access 224 one or more outputs. The output with the metadata output labels is returned 226 or provided to the decision engine. The output labels, which reflect or include ethics scores, may be used in making a decision. Thus, a decision is performed 228 or executed based on the label or, more specifically, on the ethics score included in the label. This may include proceeding with an automated decision or seeking additional input.

For example, a user may run a conversion algorithm of a data set. Two assets (algorithm A and algorithm B) are selected for the conversion algorithm by accessing the ethics datastore. The asset tracking engine 206 registers the assets that have been selected. In this example, algorithm A has an ethics score of 80 and algorithm B has an ethics score of 30.

Algorithm A is run against a data set and an output is returned or generated. The output is added to the metadata control plane and an output metadata label is added to the output's record in the ethics datastore. In one example, the label (or multiple labels) may include a timestamp, the asset (and/or version) and the ethics score. Thus, the ethics score is attached to the output of the asset.

Algorithm B is run against the same data set and the metadata control plane similarly adds a label to the output of algorithm B.

In one example, a script may exist that, when the results or outputs of the selected assets (Algorithms A and B) do not match, the output from the algorithm associated with a higher ethics score is used. A review may also be triggered to have a person review the outputs. By selecting the asset with the higher ethics score, this ensures that any automated decisions or outputs are aligned or better aligned with any ethical requirements or guidelines.

FIG. 3 discloses aspects of a datastore for ethics related data and for storing ethics scores. FIG. 3 illustrates an example architecture of a datastore 300 for storing ethics related data. The datastore 300 may store context, rules, and data points for ethics pillars and associated assets such as algorithms, AI, software, or the like. The datastore 300 stores organization content for contributors and peer reviewers of content. Scores, tallies, and historian data are also stored for auditing and/or traceability.

The datastore 300 stores information related to generating and measuring AI (artificial intelligence) ethics. The ethics datastore 300, which may be configured to store, and version, context, rules and data points for various defined pillars of AI ethics and associated assets, where such assets may include, for example, algorithms, AI platforms comprising hardware and/or software, hardware, and software. Example embodiments of a datastore 300 may store organizational content for contributors and peer reviewers of content. Embodiments of the datastore 300 may store ethics scores, tallies and historical data for ongoing traceability. An example of a service that may be employed by some example embodiments is an AI ETS (Ethics Tally Service) that may perform various operations including, but not limited to, continuous generation of asset AI ethics scores for overall assets based on self, peer, and machine, assessment (1) across all AI ethics pillars, (2) on individual pillars per asset per version per context, (3) as compared to an organizational pillar requirements, and (4) over a defined period of time. The AI ETS may be performed with respect to data and metadata stored in a data structure, an example implementation of which is discussed in connection with FIG. 3.

The AI ethics of an asset, organization, or other entity, may be scored in various ways, and the scope of the invention is not limited to the use of any particular AI ethics scoring approach. Some example embodiments may employ the five so-called ‘pillars’ of AI ethics that are recognized by industry. These pillars include: (1) accountability; (2) value alignment; (3) explainability; (4) fairness; and (5) user data rights. Note that the scope of the invention is not limited to these pillars, and more, and different, pillars may be employed in some embodiments. In general, the efforts of an individual and/or an enterprise to address ethical considerations in their development and use of an AI model may be assessed, on various bases, with respect to each of the different pillars.

Example embodiments may thus include an extensible data structure built around a group of pillars, such as those mentioned above. An example of such a data structure is denoted generally as the datastore 300 in FIG. 3, which is directed to an example implementation of an AI ethics datastore data structure. In general, the datastore 300 may be configured to support the collection and versioning of data and metadata relating to one or more of the pillars, which are collectively denoted at 302.

Various details may then be identified and employed which may enable each of the pillars 302 to be measurable as a constituent of the overall context for an asset. That is, the context identified for a pillar may provide a measurable indicator of an extent to which, with regard to that particular pillar, the asset measures up, or does not measure up, with respect to an established standard for that pillar. As explained below, the overall measured context for an asset may be compared with a required context established by an organization or other entity. The context data 304 respectively associated with each of the pillars 304 may be represented in multiple different ways. For example, context data 304 may be expressed in terms of, or comprise, elements such as minimum action checklists, natural language requirements, workflows, and assignment of signature by completing parties.

After the overall context, which may comprise various context data 304 associated with a respective pillar, has been established for a particular asset, various methods for assessing the asset with respect to the various pillars, using the context that has been determined for each pillar, may be applied. The data, metadata, and other information gathered in connection with these measurement processes may be stored in the datastore 300. No particular measurement process, or group of measurement processes, is required to be performed for any particular embodiment.

As shown in FIG. 3, a self-assessment may be performed by a human for any one or more of the pillars 302. For example, a user, such as the creator of an asset such as an AI model, may keep a record 306 of actions taken by the user during development of the AI model. Further, the user use may self-score the completeness of her actions, for the asset, against the context of a specific pillar, or pillars.

Yet other measurement processes may be performed, with respect to one or more pillars, by a machine rather than by a human. For example, a machine implemented measurement process may independently, and automatically according to a schedule or other basis, validate the measurable context data 304 against supplied data. For example, the context data 304 for ‘user data rights’ may be evaluated against data privacy standards promulgated by an authority, or by a company, using a language processing program or algorithm. The outcome of the machine implemented measurement process may be stored as machine assertion data 308. The machine implemented measurement may use any of a variety of mechanisms to assess the context data 304 against the supplied data. Such mechanisms may include, but are not limited to, field-matching, and natural language processing (NLP).

Still other measurement processes may be performed by one or more peers of the person, or persons, who have created, or are in the process of creating, software such as an AI model. In one example, a peer assessment process may be performed which generates, for one or more of the pillars, corresponding peer assessment data 310 that captures an extent to which an asset is determined, by the peers, to comply with various established standards. In one particular example, a peer assessment process may involve the crowdsourcing of external assessments of supplied actions, that is, actions performed concerning the asset, and performance of an independent audit of asset compliance for each asset based on the context data 304 for one or more of the pillars 302. The peer assessment may be enabled, for example, by inspection of the context data 304, and/or the transparency of reported actions via self-assessment by a user associated with the asset.

With respect to the various context assessment processes referenced in FIG. 3, it is noted that because context and learning change may over time, embodiments may enable versioning and tracing of assets, development of measurable context, self-assessment, machine assessment, and peer assessment over time, as well as the generation of score tallies 312 for the various data relating to a pillar 302. In some embodiments, development or modification of an asset may be temporarily, or permanently, halted based on the outcome of one or more context assessment processes. As part of a halt, a user may be informed as to the reason for the stop, and advised as to the corrective action(s) that need to be taken to re-start the model development process. This approach may be relatively efficient as some problems may be resolved on the fly during asset development, rather than waiting to identify and resolve those problems after the fact when the model has been completed.

With continued reference to the example datastore 300, it was noted earlier herein that embodiments of the datastore 300 may support storage of versioned, asset-specific, independent context, by pillar, and crossing all assessment mechanisms. The datastore 300 may also store ongoing tallying of scores 312 at the pillar level, and at an overall asset level whose score may be obtained by adding all the scores 312 together. This approach may enable an any point-in-time representation of a score 312 at the pillar level and/or an overall asset-level score. Each asset may be associated with an ethics score. The ethics score may be the overall asset-level score and is generally representative of how the ethics represented in the datastore 300 align with the asset.

While the data generated and evaluated by example embodiments is valuable, it may be a non-trivial exercise to store all of that data in the datastore 300, at least because the data may not scale to an extent that enables it to be efficiently stored and accessed. As such, example embodiments may employ the use of metadata tags, such as the example metadata tags 314 (or labels), and rules associated with organizations and contributors, as well as peer and access historians 316 to enable a usable, repeatable process for accessing and utilizing the score data in decision making. For example, a user may request context data 304 by specifying an array where that context data 304 is stored, and one or more tags that specifically identify the requested context data 304.

In general, example embodiments may enable an organization, such as a group of contributors, to create minimum context requirements for a pillar, or pillars. Additional context requirements and context data may be added to the minimum context requirements, but the minimum context requirements may be those necessary to enable a meaningful assessment of the performance of an asset and/or company with respect to a particular pillar, or pillars.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, ethics operations and ethics related operations, which may include, tagging operations, scoring operations, decision making operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, virtual machines (VM), or containers.

Particularly, devices in the operating environment may take the form of software, physical machines, VMs, containers, or any combination of these, though no particular device implementation or configuration is required for any embodiment.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: receiving an output from an automated process that operated on an input asset, labeling the output with an ethics score associated with the input asset, receiving the output into a decision engine configured to make a decision based on the output, evaluating the ethics score, by the decision engine, and making the decision when the ethics score is above a threshold score, wherein input is requested when the ethics score is below or equal to the threshold score.

Embodiment 2. The method of embodiment 1, further comprising seeking input from a user when the ethics score is below or equal to the threshold score.

Embodiment 3. The method of embodiment 1 and/or 2, further comprising retrieving the ethics score from an ethics datastore, wherein the ethics score is based on ethics pillars, context, self-measurement methods, machine assertion methods, and peer assessments.

Embodiment 4. The method of embodiment 1, 2, and/or 3, further comprising recording a decision made by the decision engine in a historian, wherein the historian is part of an ethics datastore.

Embodiment 5. The method of embodiment 1, 2, 3, and/or 4, further comprising determining whether the decision is a test decision or a production decision, wherein the test decision is performed regardless of the ethics score and wherein the production decision is performed without user input only if the ethics score is above the threshold score.

Embodiment 6. The method of embodiment 1, 2, 3, 4, and/or 5, further comprising: selecting a first algorithm and a second algorithm and generating, respectively, a first output and a second output, labeling each of the first output and the second output with, respectively, ethics scores of the first algorithm and the second algorithm, selecting, as the automated process, the first algorithm when the ethics score of the first algorithm is higher than the ethics score of the second algorithm or selecting, as the automated process, the second algorithm when the ethics score of the second algorithm is higher than the ethics score of the first algorithm.

Embodiment 7. The method of embodiment 1, 2, 3, 4, 5, and/or 6, wherein the automated process is an artificial intelligence algorithm.

Embodiment 8. The method of embodiment 1, 2, 3, 4, 5, 6, and/or 7, further comprising recording the output and associated ethics score in a historian and recording actions associated with using the output by the decision engine.

Embodiment 9. The method of embodiment 1, 2, 3, 4, 5, 6, 7, and/or 8, wherein the input includes allowing the decision to be made, accepting a risk of an ethical violation, terminating the decision, or seeking a new automated process to generate a different output for consideration by the decision engine.

Embodiment 10. The method of embodiment 1, 2, 3, 4, 5, 6, 7, 8, and/or 9, wherein the ethics engine is configured to track the asset and the output of the asset and to label the output.

Embodiment 11. The method of embodiment 1, 2, 3, 4, 5, 6, 7, 8, 8, and/or 10, further comprising labeling the output with an ethics score of the automated process and/or an ethics score of hardware associated with generating the output.

Embodiment 12. A method for performing any of the operations, methods, or processes, or any portion of any of these, or any combination thereof, disclosed herein.

Embodiment 13. A non-transitory storage medium having stored therein instructions that are executable by one or more hardware processors to perform operations comprising the operations of any one or more of embodiments 1-12.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

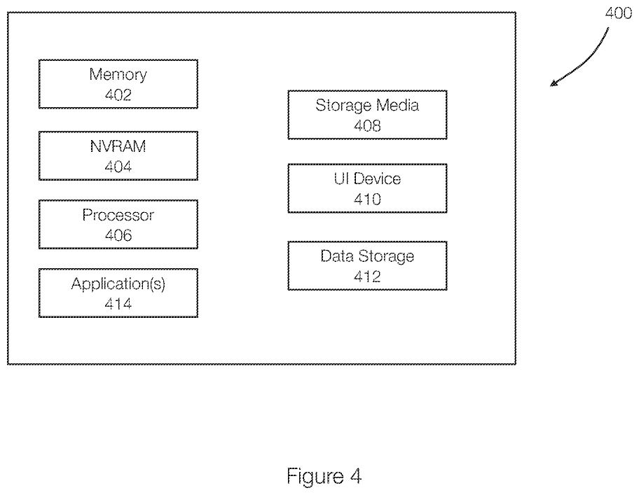

With reference briefly now to FIG. 4, any one or more of the entities disclosed, or implied, by the Figures and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving an output from an automated process that operated on an input asset;
labeling the output with an ethics score associated with the input asset;
receiving the output into a decision engine configured to make a decision based on the output;
evaluating the ethics score, by the decision engine, and making the decision when the ethics score is above a threshold score, wherein input is requested when the ethics score is below or equal to the threshold score.

2. The method of claim 1, further comprising seeking input from a user when the ethics score is below or equal to the threshold score.

3. The method of claim 1, further comprising retrieving the ethics score from an ethics datastore, wherein the ethics score is based on ethics pillars, context, self-measurement methods, machine assertion methods, and peer assessments.

4. The method of claim 1, further comprising recording a decision made by the decision engine in a historian, wherein the historian is part of an ethics datastore.

5. The method of claim 1, further comprising determining whether the decision is a test decision or a production decision, wherein the test decision is performed regardless of the ethics score and wherein the production decision is performed without user input only if the ethics score is above the threshold score.

6. The method of claim 1, further comprising:
selecting a first algorithm and a second algorithm and generating, respectively, a first output and a second output;
labeling each of the first output and the second output with, respectively, ethics scores of the first algorithm and the second algorithm;
selecting, as the automated process, the first algorithm when the ethics score of the first algorithm is higher than the ethics score of the second algorithm or selecting, as the automated process, the second algorithm when the ethics score of the second algorithm is higher than the ethics score of the first algorithm.

7. The method of claim 1, wherein the automated process is an artificial intelligence algorithm.

8. The method of claim 1, further comprising recording the output and associated ethics score in a historian and recording actions associated with using the output by the decision engine.

9. The method of claim 1, wherein the input includes allowing the decision to be made, accepting a risk of an ethical violation, terminating the decision, or seeking a new automated process to generate a different output for consideration by the decision engine.

10. The method of claim 1, wherein the ethics engine is configured to track the asset and the output of the asset and to label the output.

11. The method of claim 1, further comprising labeling the output with an ethics score of the automated process and/or an ethics score of hardware associated with generating the output.

12. A non-transitory storage medium having stored therein instructions that are executable by one or more hardware processors to perform operations comprising:
receiving an output from an automated process that operated on an input asset;
labeling the output with an ethics score associated with the input asset;
receiving the output into a decision engine configured to make a decision based on the output;
evaluating the ethics score, by the decision engine, and making the decision when the ethics score is above a threshold score, wherein input is requested when the ethics score is below or equal to the threshold score.

13. The non-transitory storage medium of claim 12, further comprising seeking input from a user when the ethics score is below or equal to the threshold score.

14. The non-transitory storage medium of claim 12, further comprising retrieving the ethics score from an ethics datastore, wherein the ethics score is based on ethics pillars, context, self-measurement methods, machine assertion methods, and peer assessments.

15. The non-transitory storage medium of claim 12, further comprising recording a decision made by the decision engine in a historian, wherein the historian is part of an ethics datastore.

16. The non-transitory storage medium of claim 12, further comprising determining whether the decision is a test decision or a production decision, wherein the test decision is performed regardless of the ethics score and wherein the production decision is performed without user input only if the ethics score is above the threshold score.

17. The non-transitory storage medium of claim 12, further comprising:
selecting a first algorithm and a second algorithm and generating, respectively, a first output and a second output;
labeling each of the first output and the second output with, respectively, ethics scores of the first algorithm and the second algorithm;
selecting, as the automated process, the first algorithm when the ethics score of the first algorithm is higher than the ethics score of the second algorithm or selecting, as the automated process, the second algorithm when the ethics score of the second algorithm is higher than the ethics score of the first algorithm.

18. The non-transitory storage medium of claim 12, further comprising:
comprising labeling the output with an ethics score et of the automated process and/or an ethics score of hardware associated with generating the output.

19. The non-transitory storage medium of claim 12, wherein the automated process is an artificial intelligence algorithm, further comprising recording the output and associated ethic score in a historian and recording actions associated with using the output by the decision engine.

20. The non-transitory storage medium of claim 12, wherein the input includes allowing the decision to be made, accepting a risk of an ethical violation, terminating the decision, or seeking a new automated process to generate a different output for consideration by the decision engine.
